(19) United States
(12) Patent Application Publication
(10) Pub. No.: US 2025/0119517 A1
(43) Pub. Date: Apr. 10, 2025

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Yuto YOSHIDA, Kanagawa (JP)

(21) Appl. No.: 18/907,647

(22) Filed: Oct. 7, 2024

(30) Foreign Application Priority Data
Oct. 10, 2023 (JP) 2023-175167

(51) Int. Cl. H04N 13/111; G06T 7/55; G06T 7/80; G06T 7/90; G06V 10/26; G06V 10/764

(52) U.S. Cl. CPC H04N 13/111; G06T 7/55; G06T 7/80; G06T 7/90; G06V 10/26; G06V 10/764

(57) ABSTRACT

The image processing apparatus obtains data of a plurality of captured images obtained by capturing an object from a plurality of directions and image capturing camera parameters, which are camera parameters corresponding to each of the plurality of captured images, generates a plurality of object images by extracting an image region corresponding to an image of the object from each of the plurality of captured images, generates object image camera parameters, which are camera parameters corresponding to each of the plurality of object images, based on the image capturing camera parameters and information indicating a position of an image region corresponding to the image of the object in the plurality of captured images, and obtains spatial information representing a space in which the object exists based on the plurality of object images and the object image camera parameters corresponding to each of the plurality of object images.

### BACKGROUND

### Field

The present disclosure relates to a technique to estimate spatial information in an image capturing-target region by an imaging apparatus.

### Description of the Related Art

There is a technique to estimate spatial information in an image capturing-target region by an imaging apparatus based on a plurality of pieces of captured image data obtained by image capturing from a plurality of viewpoints and camera parameters of each imaging apparatus used for the image capturing. With this technique, it is possible to perform rendering of an image (in the following, called “virtual viewpoint image”) corresponding to an appearance from an arbitrary virtual viewpoint (in the following, called “virtual viewpoint”). U.S. Pat. No. 11,308,659 (in the following, called “Patent Document 1”) has disclosed an NeRF (Neural Radiance Field) method as an algorithm performing rendering of a virtual viewpoint image. Specifically, the NeRF method disclosed in Patent Document 1 compares color information on each pixel in a virtual viewpoint image, which is obtained from viewpoint information indicating a position, a viewing direction and the like of a viewpoint at which image capturing is performed, and estimated spatial information, with color information on each pixel in a captured image. Following this, the NeRF method generates spatial information in accordance with a captured image by performing learning by feeding back an error between these pieces of color information to the spatial information. According to the NeRF method disclosed in Patent Document 1, it is possible to generate a virtual viewpoint image whose realism is high by using the generated spatial information.

In a case where learning of spatial information is performed, sampling processing of color information for each pixel in each of a plurality of captured images obtained by image capturing from multiple viewpoints and error calculation processing are performed. Because of this, the calculator performing learning of spatial information is required to have high parallelism in the above-described sampling processing and error calculation processing in order to perform processing of learning at high speed, and generally, for these pieces of processing, a GPU (Graphics Processing Unit) is used.

### SUMMARY

In a case where the number of captured images is large, that is, the number of viewpoints is large and the resolution of each captured image is high, on a condition that a plurality of captured images is loaded onto a graphics memory (in the following, described as “VRAM”) at the same time, the memory usage relating to the VRAM becomes very high. Because of this, there is such a problem that there is a case where the VRAM usage is limited due to being used for another calculation or that there is a case where it is difficult to perform the loading itself of part of a plurality of captured images onto the VRAM. For example, in a case where a captured image having each pixel value of 4K (3840× 2160) pixels in the single-precision floating-type format in each channel of RGB is loaded onto the VRAM by the number corresponding to 100 viewpoints, the VRAM needs a tremendous capacity of about 10 GB.

The present disclosure has been made in order to solve the above-described problem and an object is to provide an image processing technique for reducing the memory usage in a case where learning of spatial information is performed.

The image processing apparatus according to the present disclosure includes: one or more hardware processors; and one or more memories storing one or more programs configured to be executed by the one or more hardware processors, the one or more programs including instructions for: obtaining data of a plurality of captured images obtained by capturing an object from a plurality of directions and image capturing camera parameters, which are camera parameters corresponding to each of the plurality of captured images; generating a plurality of object images by extracting an image region corresponding to an image of the object from each of the plurality of captured images; generating object image camera parameters, which are camera parameters corresponding to each of the plurality of object images based on the image capturing camera parameters and information indicating a position of an image region corresponding to the image of the object in the plurality of captured images; and obtaining spatial information representing a space in which the object exists based on the plurality of object images and the object image camera parameters corresponding to each of the plurality of object images.

Further features of various embodiments will become apparent from the following description of exemplary embodiments with reference to the attached drawings.

### BRIEF DESCRIPTION OF THE DRAWINGS

FIG. 1 is a block diagram showing one example of a logic configuration of an image processing apparatus according to Embodiment 1;

FIG. 2 is a block diagram showing one example of a hardware configuration of the image processing apparatus according to Embodiment 1;

FIG. 3A and FIG. 3B are each a flowchart showing one example of a processing flow of the image processing apparatus according to Embodiment 1;

FIG. 4A to FIG. 4C are each a diagram schematically showing one example of an aspect of various pieces of data in obtaining processing of spatial information of the image processing apparatus according to Embodiment 1;

FIG. 5 is a diagram for explaining one example of an aspect of generation processing of object image camera parameters in a camera parameter generation unit according to Embodiment 1;

FIG. 6 is a diagram showing a relationship between FIGS. 6A and 6B;

FIGS. 6A and 6B are schematic diagrams showing one example of a change in memory usage at each processing step in the image processing apparatus according to Embodiment 1;

FIG. 7 is a block diagram representing one example of a logic configuration of an image processing apparatus according to Embodiment 2;

FIG. 8 is a flowchart showing one example of a processing flow of the image processing apparatus according to Embodiment 2;

FIG. 9A to FIG. 9D are each a diagram schematically showing one example of an aspect of various pieces of data from obtaining processing of captured image data until generation processing of object image camera parameters in the image processing apparatus according to Embodiment 2;

FIG. 10A and FIG. 10B are each a diagram showing one example of a GUI screen that an image processing apparatus 100 according to Embodiment 2 displays;

FIG. 11 is a flowchart showing one example of a processing flow of an image processing apparatus according to another Embodiment; and

FIG. 12A to FIG. 12E are each a diagram schematically showing one example of an aspect of various pieces of data from obtaining processing of captured image data until generation processing of object image camera parameters in the image processing apparatus according to another Embodiment.

### DESCRIPTION OF THE EMBODIMENTS

Hereinafter, with reference to the attached drawings, the present disclosure explains some example embodiments in detail. Configurations shown in the following embodiments are merely exemplary and some embodiments of the present disclosure are not limited to the configurations shown schematically. Note that identical components will be described with the same reference sign given thereto.

### Embodiment 1

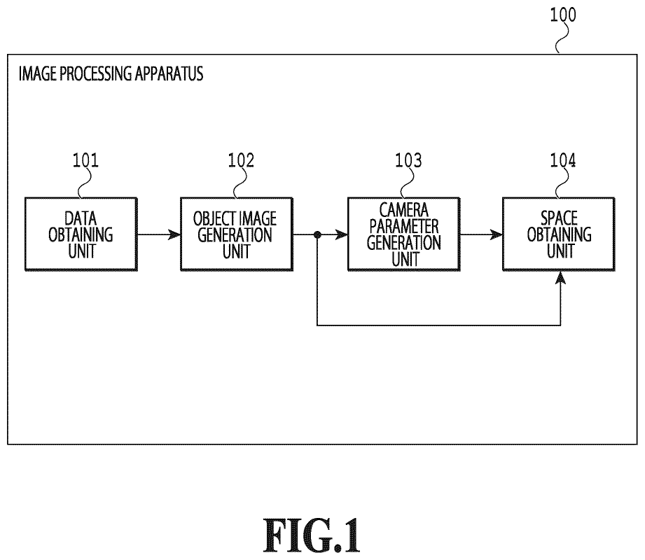

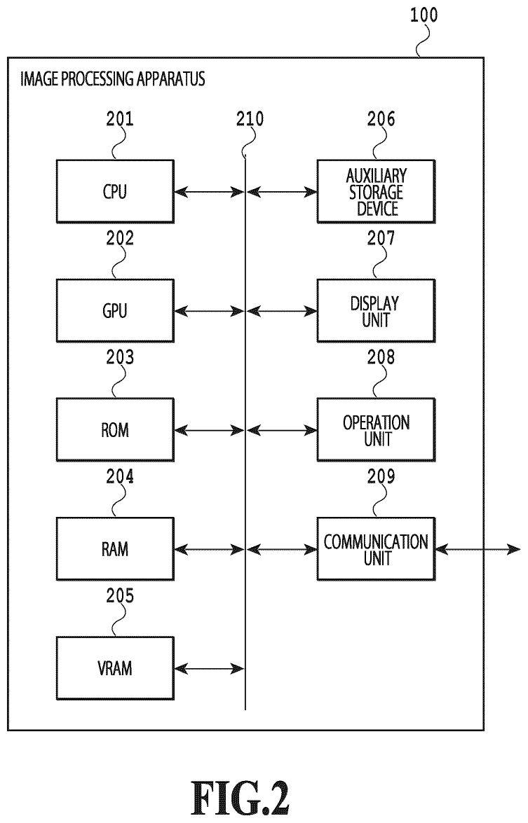

With reference to FIG. 1 to FIG. 6B, the image processing apparatus 100 according to Embodiment 1 is explained. First, with reference to FIG. 1 and FIG. 2, the configuration of the image processing apparatus 100 according to Embodiment 1 is explained. FIG. 1 is a block diagram showing one example of the logic configuration of the image processing apparatus 100 according to Embodiment 1. The image processing apparatus 100 has a data obtaining unit 101, an object image generation unit 102, a camera parameter generation unit 103, and a space obtaining unit 104. In Embodiment 1, as one example, an aspect is explained in which the image processing apparatus 100 separates a captured image into a foreground and a background, extracts the foreground as an object image, and obtains spatial information indicating a space including an object based on the extracted object image.

The data obtaining unit 101 obtains data of a plurality of captured images obtained by capturing at least one object from a plurality of directions and camera parameters of an imaging apparatus corresponding to each captured image. The camera parameters are a file in which image capturing conditions of each imaging apparatus are described or information indicating the image capturing conditions. In the following, explanation is given on the assumption that the camera parameters include information on the position, the direction of the optical axis (in the following, called “orientation”), the focal length, and the principal point of an imaging apparatus and on the size of a captured image, and further include information on coefficients relating to lens distortion, shearing or the like in addition to the above-described information as needed.

The object image generation unit 102 generates an object image. Specifically, the object image generation unit 102 first separates a captured image into a foreground and a background and extracts a rectangular region including pixels in the region separated as the foreground in the captured image. Next, the object image generation unit 102 generates an image corresponding to the extracted rectangular region in the captured image as an object image and outputs data of the generated object image. The camera parameter generation unit 103 changes part of information included in the camera parameters obtained by the data obtaining unit 101 and generates camera parameters corresponding to the object image (in the following, described as “object image camera parameters”).

The space obtaining unit 104 obtains spatial information indicating the space including the object by using the data of the object image and the object image camera parameters. The spatial information is information including at least one of density information indicating the density of the object at each position within the space, signed distance information indicating the distance from the object surface, color information, and color information depending on the direction.

The processing of each unit the image processing apparatus 100 has as a logic configuration is performed by hardware, such as a CPU (Central Processor Unit) incorporated in the image processing apparatus 100. The processing of each unit comprised by the image processing apparatus 100 may also be performed by software using a CPU or a GPU (Graphics Processor Unit) incorporated in the image processing apparatus 100 and a memory.

With reference to FIG. 2, the hardware configuration of the image processing apparatus 100 in a case where each unit the image processing apparatus 100 has as a logic configuration operates as software is explained. FIG. 2 is a block diagram showing one example of the hardware configuration in the image processing apparatus 100 according to Embodiment 1. The image processing apparatus 100 includes a computer and as shown in FIG. 2 as one example, the computer has a CPU 201, a GPU 202, a ROM 203, a RAM 204, a VRAM 205, and an auxiliary storage device 206. Further, the image processing apparatus 100 has a display unit 207, an operation unit 208, a communication unit 209, and a bus 210, in addition to the above-described configuration.

The CPU 201 causes a computer to function as each unit the image processing apparatus 100 shown in FIG. 1 has as a logic configuration by controlling the computer by using programs or programs and data stored in the ROM 203 or the RAM 204. The space obtaining unit 104 functions not only by the CPU 201 performing processing but also by the CPU 201 and the GPU 202 performing processing in cooperation with each other. The GPU 202 causes a computer to function as a main calculation unit of the space obtaining unit 104 the image processing apparatus 100 shown in FIG. 1 has as a logic configuration by controlling the computer by using programs or programs and data stored in the VRAM 205. The image processing apparatus 100 may have one or a plurality of pieces of dedicated hardware different from the CPU 201 and the GPU 202 and at least part of the processing to be performed by the CPU 201 may be performed by the dedicated hardware. As examples of the dedicated hardware, there are ASIC (Application Specific Integrated Circuit), FPGA (Field Programmable Gate Array), DSP (Digital Signal Processor) and the like.

The ROM 203 is a storage device storing information, such as programs that do not need to be changed. The RAM 204 is a storage device temporarily storing programs or data supplied from the auxiliary storage device 206, data supplied from the outside via the communication unit 209, or the like and operates as a work area of the CPU 201. The VRAM 205 is a storage device temporarily storing information, such as data supplied from the ROM 203, the RAM 204, or the auxiliary storage device 206, and operates as a work area of the GPU 202 and the information is utilized for processing by the GPU 202. The auxiliary storage device 206 includes a hard disk drive and the like and stores various pieces of data, such as image data or voice data.

The display unit 207 includes a liquid crystal display, LED (Light-Emitting Diode) or the like and displays a GUI (Graphical User Interface) for a user to operate the image processing apparatus 100, a GUP for a user to browse processing contents and the like of the image processing apparatus 100, or the like. The operation unit 208 includes a keyboard, mouse, touch panel or the like and receives operations by a user and inputs various instructions corresponding to the operations to the CPU 201. The CPU 201 also operates as a display control unit configured to control the display unit 207 and an operation control unit configured to control the operation unit 208.

The communication unit 209 is used for communication between the image processing apparatus 100 and an external device of the image processing apparatus 100. For example, in a case where the image processing apparatus 100 and an external device are connected by a wire, a communication cable is connected to the communication unit 209. In a case where the image processing apparatus 100 has a function of wirelessly communicating with an external device, the communication unit 209 comprises an antenna. The bus 210 connects each unit the image processing apparatus 100 has as a hardware configuration so that communication is possible and transmits information. In the following, explanation is given on the assumption that the display unit 207 and the operation unit 208 exist inside the image processing apparatus 100, but it may also be possible for at least one of the display unit 207 and the operation unit 208 to exist as another device outside the image processing apparatus 100.

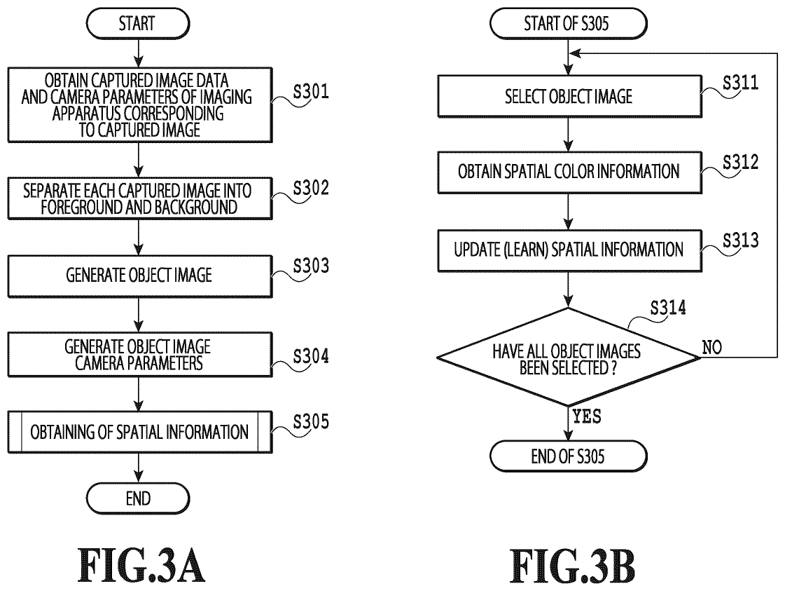

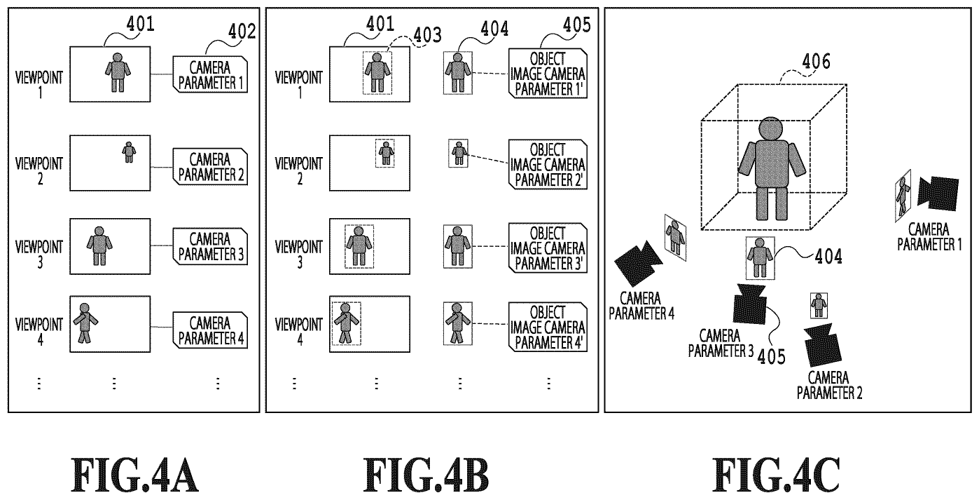

With reference to FIG. 3A and FIG. 3B, and FIG. 4A to FIG. 4C, the operation of the image processing apparatus 100 is explained. FIG. 3A and FIG. 3B are each a flowchart showing one example of a processing flow of the image processing apparatus 100 according to Embodiment 1. Specifically, FIG. 3A shows one example of a series of processing flows in the image processing apparatus 100. FIG. 3B will be described later. In the following explanation, a symbol “S” means a step (process). FIG. 4A to FIG. 4C are each a diagram schematically showing one example of an aspect of various pieces of data in obtaining processing of spatial information of the image processing apparatus 100 according to Embodiment 1. Specifically, FIG. 4A is a diagram for explaining processing at S301 shown in FIG. 3A, FIG. 4B is a diagram for explaining processing at S302 to S304 shown in FIG. 3A, and FIG. 4C is a diagram for explaining processing at S305 shown in FIG. 3A. First, at S301, the data obtaining unit 101 obtains data of a plurality of captured images 401 obtained by capturing at least one object from a plurality of directions and camera parameters 402 of an imaging apparatus corresponding to each captured image 401.

Next, at S302, the object image generation unit 102 performs separation processing to separate each captured image 401 obtained at S301 into a foreground region 403 and a background region. Here, for example, the foreground region 403 is an image region corresponding to an image of the object in the captured image 401 (in the following, called “object region”). The object image generation unit 102 separates the foreground region 403 from the background region in the captured image 401 by extracting the foreground region from the difference between the captured image obtained by image capturing in a state where no object exists (in the following, called “background image”) and the captured image 401. The separation method of the foreground region 403 and the background region is not limited to the above-described method. For example, it may also be possible for the object image generation unit 102 to separate the foreground region 403 from the background region in the captured image 401 by extracting the image region whose color is other than a specific color in the captured image 401 as the foreground region, such as in image capturing utilizing a green back or the like.

Next, at S303, the object image generation unit 102 performs the following processing for each captured image 401 obtained at S301. Specifically, at S303, the object image generation unit 102 cuts out a rectangular region including the foreground region 403 from the captured image 401, generates the cutout image as an object image 404, and outputs data of the generated object image 404. That is, the object image 404 is an image obtained by cutting out the image region judged to be the region (object region) corresponding to the image of the object in the captured image 401 into a rectangle. It may also be possible for the object image generation unit 102 to cut out a plurality of rectangular regions from the one captured image 401 obtained by image capturing from one viewpoint and generate a plurality of the object images 404 for the one captured image 401. Further, in a case where the object region is specified in units of pixels at S302, it may also be possible to configure the object image generation unit 102 so that the processing of the background region in the generated object image 404 is excluded in the obtaining processing of spatial information. For example, in order to exclude the processing of the background region in the object image 404, the object image generation unit 102 is configured as follows. Specifically, the object image generation unit 102 is configured so as to add an a channel representing transparency to the data of the object image 404 and change the degree of transparency of the pixel of the background region in the object image 404, that is, the value of the added a channel.

Next, at S304, the camera parameter generation unit 103 performs the following processing for each object image 404 generated at S303. Specifically, at S304, the camera parameter generation unit 103 generates camera parameters (object image camera parameters) 405 corresponding to the object image 404 using the camera parameters 402. Here, for the generation of the object image camera parameters 405, it is necessary to change the image size and perform correction of the information on the principal point from the camera parameters 402. The camera parameter generation unit 103 changes the image size by replacing the image size of the camera parameters 402 with the image size of the object image 404. The principal point refers to the optical center point on the captured image and is parameters represented by using image coordinates. The origin of the image coordinate system in the object image 404 is different from the origin of the captured image 401, and therefore, it is necessary to align the position of the principal point represented by the coordinates in the image coordinate system with the same position of the principal point of the captured image 401 by performing correction by an amount corresponding to the difference in the position of the origin between each image coordinate system.

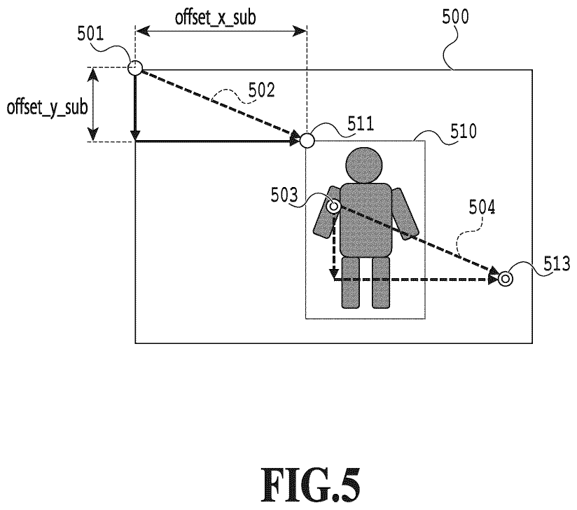

FIG. 5 is a diagram for explaining one example of an aspect of generation processing of object image camera parameters in the camera parameter generation unit 103 according to Embodiment 1. An offset 502 indicates a difference in the coordinates in the image coordinate system between an origin (in the following, called “captured image origin”) 501 of a captured image 500 and an origin (in the following, called “object image origin”) 511 of an object image 510. In the following, explanation is given by describing the value of the offset 502 in the x-direction (transverse direction) in the image coordinate system as “offset_x_sub” and the value of the offset 502 in the y-direction (longitudinal direction) in the image coordinate system as “offset_y_sub”.

A difference 504 indicates a difference in the coordinates in the image coordinate system between a principal point (in the following, called “captured image principal point”) 503 of the captured image 500 and a principal point (in the following, called “object image principal point”) 513 of the corrected object image 510. Here, the difference 504 is the same as the offset 502. Because of this, a value (cx_sub) of the difference 504 in the x-direction (transverse direction) in the image coordinate system of the object image principal point 513 and a value (cy_sub) of the difference 504 in the y-direction (longitudinal direction) in the image coordinate system thereof may be calculated based on formula (1) below.

$$( cx\_sub , cy\_sub ) = ( cx\_img - offset\_x \_sub , cy\_img - offset\_y \_sub ) \qquad formula ( l )$$

Here, cx_img is the coordinate in the x-direction (transverse direction) in the image coordinate system of the captured image principal point 503 and cy_img is the coordinate in the y-direction (longitudinal direction) in the image coordinate system thereof. By the correction such as this, the relative position of the object image principal point 513 in the camera coordinate system from the object image origin 511 matches the relative position of the captured image principal point 503 from the captured image origin 501. In a case where the object image camera parameters are generated, for information indicating the position, the orientation, and the focal length of the imaging apparatus, which are camera parameters that do not change by the cutout of part of the captured image, it may be possible to use the same values as the camera parameters.

After S304, at S305, the space obtaining unit 104 obtains spatial information on a space 406 including the object based on the object image 404 generated at S303 and the object image camera parameters 405 generated at S304. Details of the processing at S305 will be described later. Here, as one example, it is assumed that color information is dealt with as spatial information. After the processing at S305, the image processing apparatus 100 terminates the processing of the flowchart shown in FIG. 3A.

FIG. 3B is a flowchart showing one example of a flow of obtaining processing of spatial information in the space obtaining unit 104 according to Embodiment 1 and is a flowchart showing one example of a processing flow in the processing at S305 shown in FIG. 3A. First, at S311, the space obtaining unit 104 selects part or all of the plurality of the object images 404 generated at S303. Next, at S312, the space obtaining unit 104 obtains color information in the space 406 (in the following, called “spatial color information”) by using the current spatial information and the object image camera parameters 405 corresponding to the object image 404 selected at S311. Specifically, first, the space obtaining unit 104 calculates a three-dimensional ray corresponding to each pixel in the object image 404 by using the object image camera parameters 405 corresponding to the object image 404 selected at S311. Following this, the space obtaining unit 104 obtains color information (spatial color information) in the space 406 by sampling the space 406 on each ray or in the vicinity of the ray including the space on the ray by using the current spatial information and each calculated ray.

After S312, at S313, the space obtaining unit 104 calculates a color difference between the spatial color information obtained at S312 and the color information on the object image 404 selected at S311 and performs updating (learning) of the spatial information so that the calculated color difference becomes small. Here, the spatial information may be one represented by the weight parameter in the neural network as described in U.S. Pat. No. 11,308,659 (Patent Document 1) or may be one represented by the point cloud, the volume format, or the data format having values in a plurality of Gaussian distributions. Next, at S314, the space obtaining unit 104 judges whether or not all the object images 404 generated at S303 have been selected at S311. In a case where it is judged that at least part of the object images 404 have not been selected at S314, the space obtaining unit 104 returns to the processing at S311. In this case, the space obtaining unit 104 selects part or all of the remaining object images 404 not selected yet at S311. After that, the space obtaining unit 104 performs the processing at S311 to S314 repeatedly until it is judged that all the object images 404 have been selected at S314.

In a case where it is judged that all the object images 404 have been selected at S314, the space obtaining unit 104 terminates the processing of the flowchart shown in FIG. 3B, that is, the processing at S305. The processing at S312 and S313 by the space obtaining unit 104 may be performed in parallel by the GPU 202 or the like. That is, in a case where a plurality of object images is selected at S301, the space obtaining unit 104 performs the processing at S312 and S313 in parallel for the plurality of selected object images. For example, in a case where the space obtaining unit 104 selects, at S311, all the object images 404 generated at S303, it is possible to perform the processing at S312 and S313 in parallel for all the object images 404.

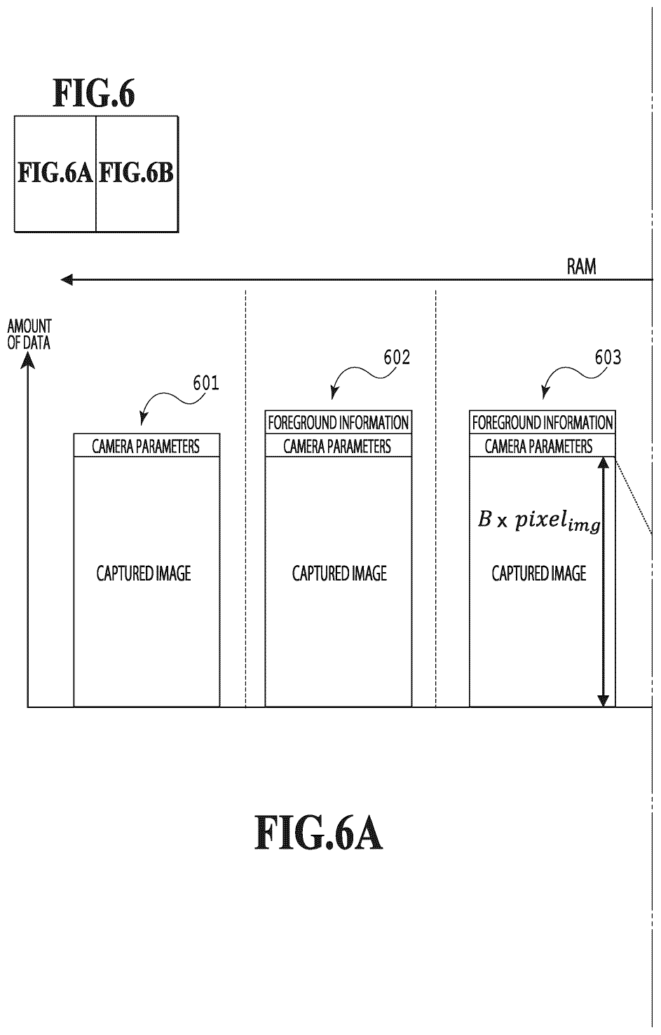

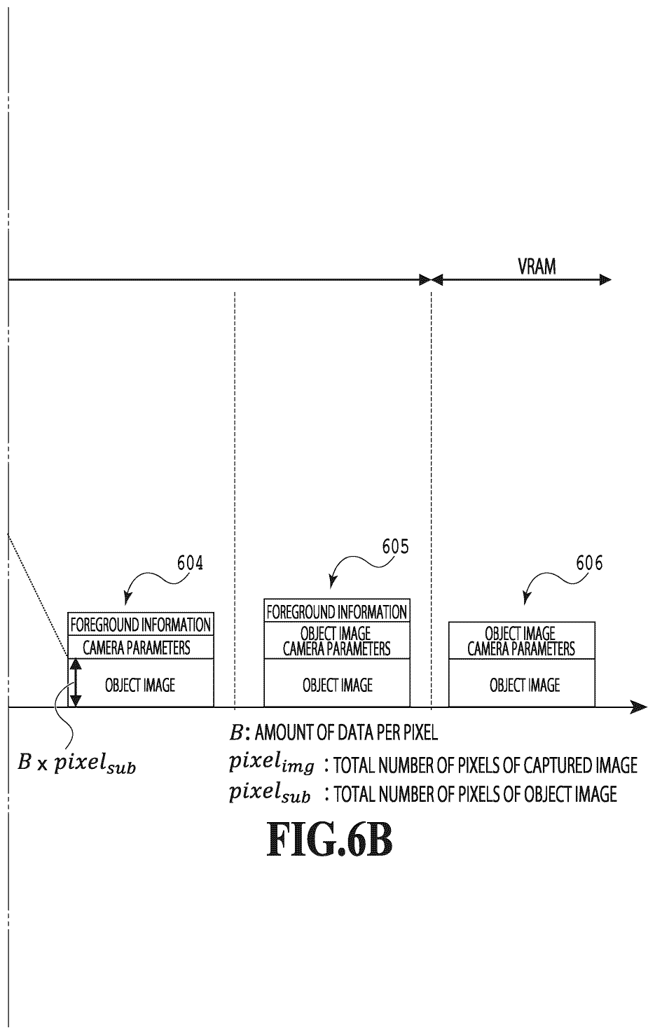

With reference to FIGS. 6A and 6B, the amount of memory that is used in each piece of processing at S301 to 305 is explained. FIGS. 6A and 6B is a diagram showing one example of a change in memory usage in the image processing apparatus 100 according to Embodiment 1. Specifically, FIGS. 6A and 6B is a schematic diagram schematically representing one example of the type of data and a change in the amount of data, which is loaded onto the RAM 204 and the VRAM 205 in each piece of processing at S301 to S305. In the following, explanation is given on the assumption that the VRAM 205 is used only in the processing of the space obtaining unit 104 among each unit the image processing apparatus 100 has as a logic configuration and in the processing of the other logic configurations, the RAM 204 is used.

The CPU 201 and the GPU 202 each has processing in which each is specialized. The CPU 201 utilizes the RAM 204 whose capacity can be increased easily as a work area, and therefore, the amount of data that the CPU 201 deals with is unlikely to become problematic. In contrast to this, the GPU 202 utilizes the VRAM 205 whose capacity is small compared to that of the RAM as a work area, and therefore, it is not possible to deal with a large amount of data in one-time processing and the amount of data becomes problematic. Because of this, in order for the GPU 202 to perform processing efficiently, it is necessary to reduce the amount of data that the GPU 202 deals with before the step at which the GPU 202 performs processing. In the following, with the amount of data being taken into consideration, each piece of processing at S301 to S305 is explained by dividing the processing into processing by the CPU 201 and processing by GPU 202.

Specifically, each piece of processing at S301 to S304 is a step of dealing with data of the captured image 401 whose capacity is large, and a generation step of the object image 404 and a generation step of the object image camera parameters 405 for which the necessity of parallel processing is low. Because of this, each piece of processing at S301 to S304 is performed by using the CPU 201 and the RAM 204.

An amount of data 601 shows an amount of data immediately after the processing at S301 is performed and shows the state of use of the RAM 204 in a case where the data of the captured image 401 and the camera parameters 402 are stored in the RAM 204, which are obtained at S301. Amounts of data 602 and 603 show amounts of data after the processing at S302 is performed and before the processing at S303 is performed. The amounts of data 602 and 603 show the state of use of the RAM 204 in a case where information indicating the foreground (in the following, called “foreground information”) separated at S302 is stored in the RAM 204, in addition to the data of the captured image 401 and the camera parameters 402.

An amount of data 604 indicates an amount of data after the processing at S303 is performed and before the processing at S304 is performed. Specifically, the amount of data 604 indicates the state of use of the RAM 204 in a case where the camera parameters 402 obtained at S301, the foreground information obtained at S302, and the data of the object image 404 generated at S303 are stored in the RAM 204. In a case where the processing at S303 is performed, the data of the captured image 401 is deleted and the data of the object image 404 is loaded onto the RAM 20 in place of the captured image 401. Here, the object image 404 is an image obtained by cutting out part of the captured image 401, and therefore, by the processing at S303, the amount of data of the image is reduced and saving of memory is implemented.

For example, the total number of pixels of all the captured images 401 obtained at S301 is taken to be pixel_{img}, the total number of pixels of all the object images 404 generated at S303 is taken to be pixel_{sub}, and the amount of data per pixel is taken to be B. In this case, the total amount of data of all the captured images 401 is B× pixel_{img} and the total amount of data of all the object images 404 is B× pixel_{sub}. Consequently, the amount of data 604 after the processing at S303 is reduced by an amount corresponding to B×(pixel_{img}−pixel_{sub}) compared to the amount of data 603 before the processing at S303. In a case where an increase in the number of viewpoints or in the resolution of an image, the measures for a plurality of frames accompanying the change in algorithm, or the like is taken into consideration, it is expected that the amount of reduction in the memory usage relating to the VRAM 205 will further increase accompanying an increase in the amount of data of captured image data.

An amount of data 605 indicates the amount of data after the processing at S304 is performed and before the processing at S305 is performed. The amount of data 605 indicates the state of use of the RAM 204 in a case where the foreground information obtained at S302, the data of the object image 404 generated at S303, and the object image camera parameters 405 generated at S304 are stored in the RAM 204. In a case where the processing at S304 is performed, the camera parameters 402 are deleted and the object image camera parameters 405 are loaded onto the RAM 204 in place of the camera parameters 402. The amount of data of the camera parameters 402 and the object image camera parameters 405 is sufficiently small compared to the amount of data of the image data. Because of this, the difference in memory usage in a case where the camera parameters 402 are replaced with the object image camera parameters 405 may be ignored.

For the obtaining processing of spatial information at S305, a high degree of parallelism is required. Because of this, the data of the object image 404 generated at S303 and the object image camera parameters 405 are transferred from the RAM 204 to the VRAM 205 and the processing at S305 is performed by using the GPU 202 and the VRAM 205. An amount of data 606 indicates the amount of data before the processing at S305 is performed. Specifically, the amount of data 606 indicates the state of use of the VRAM 205 in a case where the data of the object image 404 and the object image camera parameters 405, which are transferred from the RAM 204 to the VRAM 205, are stored in the VRAM 205. As above, the input data that is loaded onto the VRAM 205 is only the object image 404 and the object image camera parameters 405. Because of this, compared to a case where the data of all the captured images 401 is loaded onto the VRAM 205, the memory usage relating to the VRAM 205 is reduced.

As above, the image processing apparatus 100 is configured so as to generate the object image and the object image camera parameters corresponding to the object image from a plurality of captured images obtained by image capturing from a plurality of directions and camera parameters corresponding to each captured image. Further, the image processing apparatus 100 is configured so as to perform updating (learning) of spatial information by using the data of each generated object image and the object image camera parameters corresponding to each object image. According to the image processing apparatus 100 thus configured, compared to a case where the data of all the obtained captured images is loaded onto the VRAM 205, it is possible to perform updating (learning) of spatial information with less memory usage relating to the VRAM 205. Further, according to the image processing apparatus 100 thus configured, compared to a case where updating (learning) of spatial information is performed by using the data of the captured image, it is possible to perform updating (learning) of spatial information with a smaller amount of calculation of the GPU 202.

### Embodiment 2

The image processing apparatus 100 according to Embodiment 1 generates an object image by extracting the region of an object from a captured image, and therefore, the image size of each object image is different from one another. In a case where the GPU 202 performs image processing by parallel processing, the processing time is determined to be that for the object image whose image size is the maximum, and therefore, this may cause a reduction in the efficiency of the parallel processing. In Embodiment 2, an aspect is explained in which parallel processing in the GPU 202 is made efficient by dividing all the object images into image regions of a predetermined image size (in the following, called “unit region”).

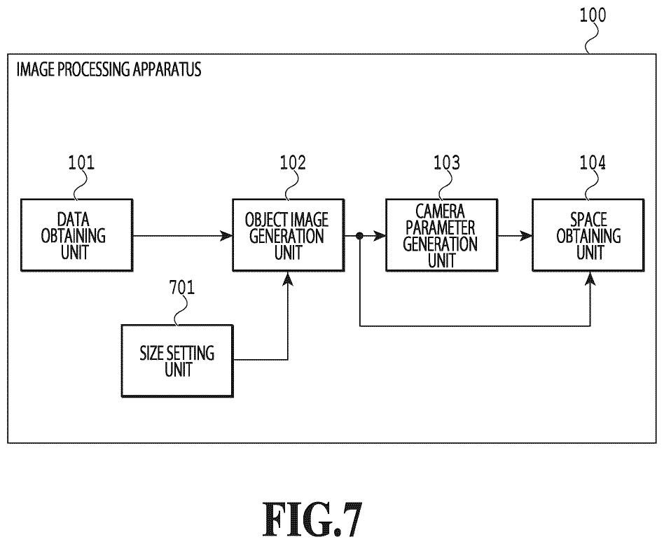

With reference to FIG. 7 to FIG. 10B, the image processing apparatus 100 according to Embodiment 2 is explained. FIG. 7 is a block diagram showing one example of a logic configuration of the image processing apparatus 100 according to Embodiment 2 (in the following, simply described as “image processing apparatus 100”). The image processing apparatus 100 has the data obtaining unit 101, a size setting unit 701, the object image generation unit 102, the camera parameter generation unit 103, and the space obtaining unit 104. The processing of the data obtaining unit 101 according to Embodiment 2 (in the following, simply described as “data obtaining unit 101”) is the same as the processing of the data obtaining unit 101 according to Embodiment 1, and therefore, explanation of the data obtaining unit 101 is omitted. The size setting unit 701 sets the size of the unit region. In the following, the object image generation unit 102 according to Embodiment 2 is explained.

The object image generation unit 102 according to Embodiment 1 generates the image as an object image, which is obtained by cutting out the rectangular region including the foreground extracted by being separated from the background from the captured image. Because of this, the image size of the object image generated by the object image generation unit 102 according to Embodiment 1 is different for different object images.

In contrast to this, the object image generation unit 102 according to Embodiment 2 (in the following, simply described as “object image generation unit 102”) generates an object image of a predetermined image size. Specifically, the object image generation unit 102 generates a plurality of object images by dividing the extracted foreground region into unit regions of the size set by the size setting unit 701 and cutting out each of a plurality of image regions obtained by the division from the captured image. The object image generation unit 102 generates a plurality of object images whose image size is the size of the unit regions whose image size is identical to one another, and therefore, the image size of the object images generated by the object image generation unit 102 is made common.

The processing of the camera parameter generation unit 103 according to Embodiment 2 (in the following, simply described as “camera parameter generation unit 103”) is the same as the processing of the camera parameter generation unit 103 according to Embodiment 1. Further, the processing of the space obtaining unit 104 according to Embodiment 2 (in the following, simply described as “space obtaining unit 104”) is the same as the processing of the space obtaining unit 104 according to Embodiment 1. Because of this, explanation of the camera parameter generation unit 103 and the space obtaining unit 104 is omitted.

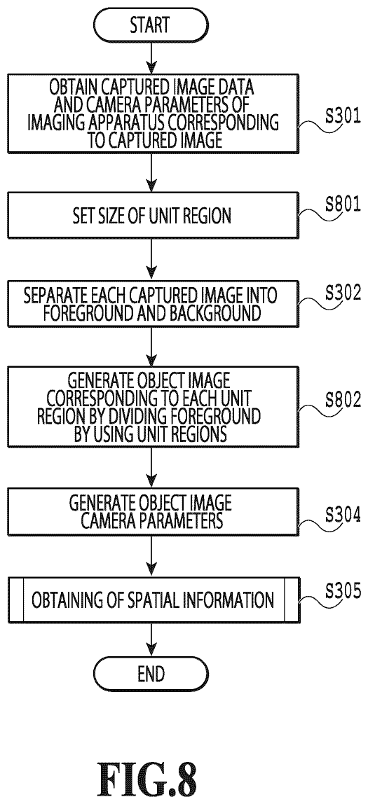

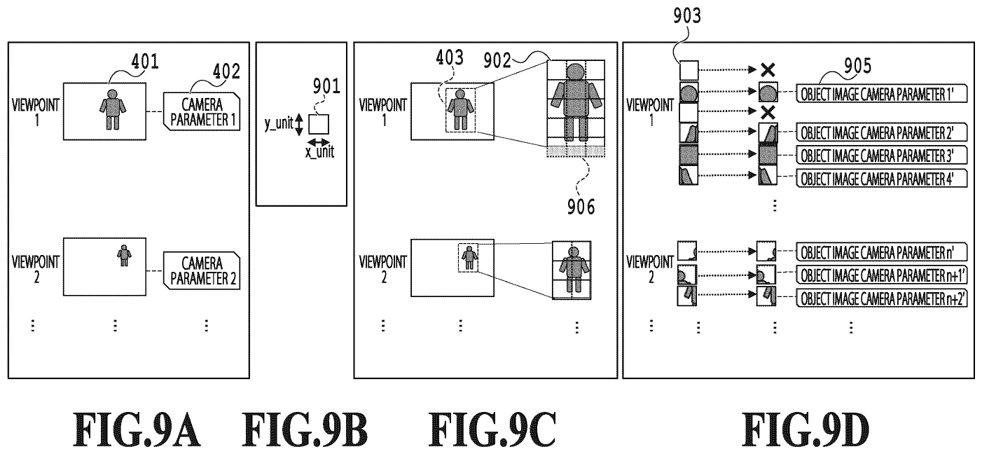

FIG. 8 is a flowchart showing one example of a processing flow of the image processing apparatus 100 according to Embodiment 2. With reference to FIG. 8, the difference between the image processing apparatus 100 and the image processing apparatus 100 according to Embodiment 1 is explained. FIG. 9A to FIG. 9D are each a diagram schematically showing one example of an aspect of various pieces of data from obtaining processing of captured image data until generation processing of object image camera parameters in the image processing apparatus 100 according to Embodiment 2. First, at S301, the data obtaining unit 101 obtains the data of a plurality of the captured images 401 and the camera parameters 402 corresponding to each captured image 401. FIG. 9A shows one example of the data that is obtained by the processing at S301 and is the same as FIG. 4A.

Next, at S801, the size setting unit 701 sets the size of a unit region 901. FIG. 9B shows one example of the unit region 901 that is set by the processing at S801. For example, the size setting unit 701 designates the width of the unit region, that is, x_unit, a length of the unit region in the x-direction (transverse direction), and the height of the unit region, that is, y_unit, a length of the unit region in the y-direction (longitudinal direction), as the size of the unit region 901. Here, it is desirable for the size of the unit region 901 to be set so that an integer multiple of the total number of pixels of one unit region is the batch size of the updating (learning) processing of spatial information. By setting the size of the unit region 901 to the size such as this, it is possible to designate the target that the space obtaining unit 104 processes in learning by one-time batch processing in units of images in place of units of pixels. Due to this, in the space obtaining unit 104, the processing of each batch is made easy. Here, the batch size in the updating (learning) processing of spatial information refers to the number of pixels for which it is possible to perform an error calculation en bloc in one-time learning. The value of the ratio between x_unit and y_unit is not limited to 1 and it may be possible to set an arbitrary value.

After S801, the image processing apparatus 100 performs processing at S302 and S802. FIG. 9C shows one example of data that is obtained by the processing at S302 and S802. Specifically, after S801, at S302, the object image generation unit 102 performs separation processing to separate the foreground region 403 from the background region for each captured image 401 obtained at S301 as in Embodiment 1.

Next, at S802, the object image generation unit 102 generates an object image. More specifically, at S802, the object image generation unit 102 first performs division processing to divide each foreground region 902 extracted at S302 into a plurality of the unit regions 901 so that there is no overlapping among them. “Division without overlapping” described here also means division with almost no overlapping, allowing somewhat overlapping, in addition to the meaning of strict division without overlapping. Following S802, the object image generation unit 102 generates an object image 903 by cutting out each unit region 901 from the captured image 401, which is obtained by dividing the foreground region 902.

In dividing the foreground region 902 into a plurality of the unit regions 901 so that there is no overlapping, there is a case where it is not possible to divide the foreground region 902 into an integer number of unit regions 901 and part of the unit region 901 bulges out of the foreground region 902. In the case such as this, for example, it may also be possible for the object image generation unit 102 to generate the object image 903 by cutting out the unit region 901 including pixels 906 outside the foreground region 902 in the captured image 401. Further, in a case where the foreground region 403 of the captured image 401 is specified in units of pixels, it is possible to reduce the number of pixels of the object image 903 by adding processing to remove the pixel corresponding to the pixel specified as the foreground region 403 from the object image 903. That is, by adding the processing, it is possible to more suppress the memory usage relating to the VRAM 205.

After S802, at S304, the camera parameter generation unit 103 generates object image camera parameters 905 corresponding to each object image 903 generated at S802. The generation method of the object image camera parameters 905 is the same as the generation method of the object image camera parameters 405, and therefore, explanation is omitted. After S304, at S305, the space obtaining unit 104 obtains spatial information on the space 406 including the object based on the object image 903 generated at S802 and the object image camera parameters 905 generated at S304. The processing at S305 according to Embodiment 2 is the same as the processing at S305 according to Embodiment 1, and therefore, explanation is omitted. After the processing at S305, the image processing apparatus 100 terminates the processing of the flowchart shown in FIG. 3A.

Here, in Embodiment 2, the image size of all the object images 903 is made common. Because of this, in a case where the obtaining processing of spatial information is performed in parallel for a plurality of the object images 903, a large difference in the processing time in each object image 903 does not occur. Consequently, it is possible for the image processing apparatus 100 according to Embodiment 2 to implement more efficient parallel processing compared to the image processing apparatus 100 according to Embodiment 1.

As above, the image processing apparatus 100 is configured so as to generate the object image and the object image camera parameters corresponding to the object image from a plurality of captured images obtained by image capturing from a plurality of directions and the camera parameters corresponding to each captured image. Here, the image processing apparatus 100 is configured so that the object image to be generated has an image size corresponding to the predetermined unit region or an image size smaller than or equal to the image size. Further, the image processing apparatus 100 is configured so as to perform updating (learning) of spatial information by using the data of each generated object image and the object image camera parameters corresponding to each object image. According to the image processing apparatus 100 thus configured, it is possible to perform updating (learning) of spatial information with less memory usage relating to the VRAM 205 compared to the case where the data of all the obtained captured images is loaded onto the VRAM 205. Further, according to the image processing apparatus 100 thus configured, it is possible to perform updating (learning) of spatial information with a smaller amount of calculation of the GPU 202 compared to the case where updating (learning) of spatial information is performed by using the data of the captured image. Furthermore, according to the image processing apparatus 100 thus configured, in the obtaining processing of spatial information, it is possible to suppress a reduction in the efficiency of the parallel processing due to the variations of the image size for each object image, and therefore, is it possible to implement more efficient parallel processing for the object image.

The explanation so far is given on the assumption that the image processing apparatus 100 obtains spatial information as the results of learning, but it may also be possible for the image processing apparatus 100 to generate an image by using obtained spatial information and present the generated image to a user by displaying the image on the display unit 207 as the results of learning. Specifically, for example, first, the image processing apparatus 100 determines a virtual viewpoint at which rendering of the image is performed (in the following, called “rendering viewpoint”) based on the input camera parameters 402 or the object image camera parameters 405 or 905. Following this, the image processing apparatus 100 generates an image corresponding to the appearance of the space 406 from the determined rendering viewpoint by using the obtained spatial information and displays the image on the display unit 207 as the results of learning.

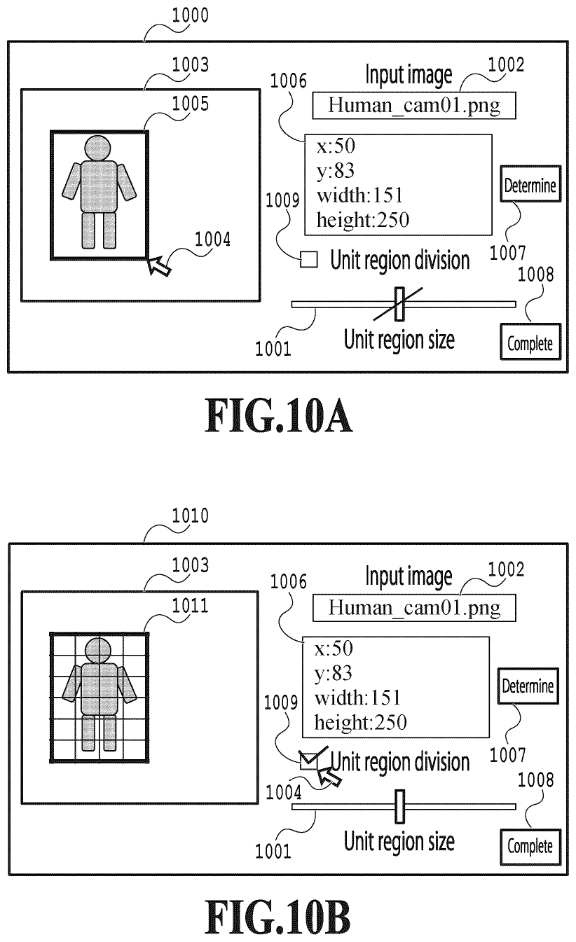

Further, the explanation so far is given on the assumption that the object region in the captured image 401 is extracted as the foreground region 403 by the foreground/background separation, but the extraction method of the foreground region 403 is not limited to the method by foreground/background separation. For example, the foreground region may be set by appending of annotation by a user using a predetermined GUI to the object region in the captured image 401. In the following, with reference to FIG. 10A and FIG. 10B, a specific example of appending of annotation by a user using a GUI is explained.

FIG. 10A and FIG. 10B are each a diagram showing one example of a GUI screen 1000 and that of a GUI screen 1010, which the image processing apparatus 100 according to Embodiment 2 displays. A user sets an image region including the foreground region by appending annotation to the object region in the captured image 401 by the GUI screen 1000. The GUI screen 1000 has a file name box 1002, an image display region 1003, an information box 1006, a Determine button 1007, a Complete button 1008, a Unit region division button 1009, and a slider bar 1001.

In a case where a file name is input to the file name box 1002 by a user, the image processing apparatus 100 displays the captured image 401 corresponding to the file name among a plurality of the captured images 401 obtained by the data obtaining unit 101 in the image display region 1003. In a case where an object region 1005 is set in the image display region 1003 by the operation of a cursor 1004 by a user, the image processing apparatus 100 displays region information indicating the set object region in the information box 1006. In a case where the Determine button 1007 is pressed down by a user in the state where the object region is set, the image processing apparatus 100 generates an object image based on the region information indicating the set object region in the object image generation unit 102. Further, the image processing apparatus 100 generates object image camera parameters based on the region information and the camera parameters 402 corresponding to the captured image 401 with the file name designated in the file name box 1002 in the camera parameter generation unit 103.

In a case where the Complete button 1008 is pressed down by a user, the image processing apparatus 100 obtains spatial information based on all the generated object images and object image camera parameters in the space obtaining unit 104.

Specifically, a user presses down the Complete button 1008 after completing the generation of the object images corresponding to all the captured images 401 obtained by the data obtaining unit 101. Due to this, the space obtaining unit 104 of the image processing apparatus 100 obtains spatial information based on the data of all the generated object images and the object image camera parameters corresponding to each object image.

The Unit region division button 1009 includes a checkbox and it is possible for a user to switch between ON and OFF of the Unit region division button 1009. In a case where the Unit region division button 1009 is set to ON, the image processing apparatus 100 causes the display to make a transition from the GUI screen 1000 into the GUI screen 1010 and displays an image 1011 obtained by dividing the set object region by using the unit regions in the image display region 1003. It is possible for a user to change the size of the unit region by performing the operation to slide the slider of the slider bar 1001 by using the cursor 1004 and the size of the unit region is set by the change operation. A user sets an object region by operating the cursor, the various buttons, and the slider bar while referring to the captured image displayed in the image display region 1003. Further, the image processing apparatus 100 generates the object image and the object image camera parameters based on the set object region and obtains spatial information based on the generated object image and object image camera parameters.

By designing the configuration as above, it is possible for a user to set a desired image region as an object region in each captured image 401.

### OTHER EMBODIMENTS

The image processing apparatus 100 according to Embodiment 1 and Embodiment 2 extracts or sets the object region, that is, the foreground region by foreground/background separation or setting by a user and generates the object image based on the foreground region. The extraction or setting method of the object region in the captured image is not limited to that described above and the foreground region may be extracted or set by a method other than the above-described method.

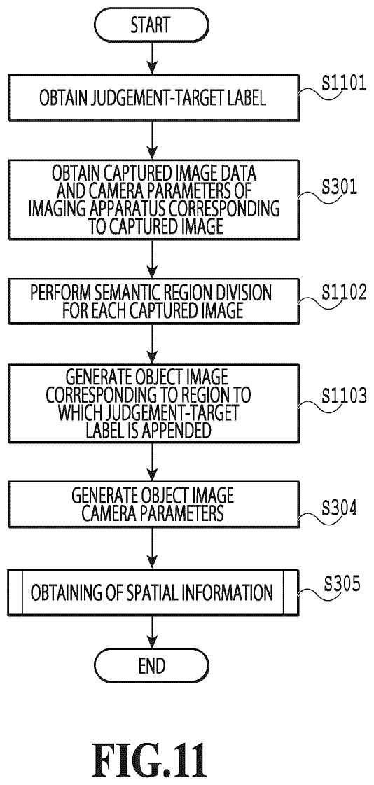

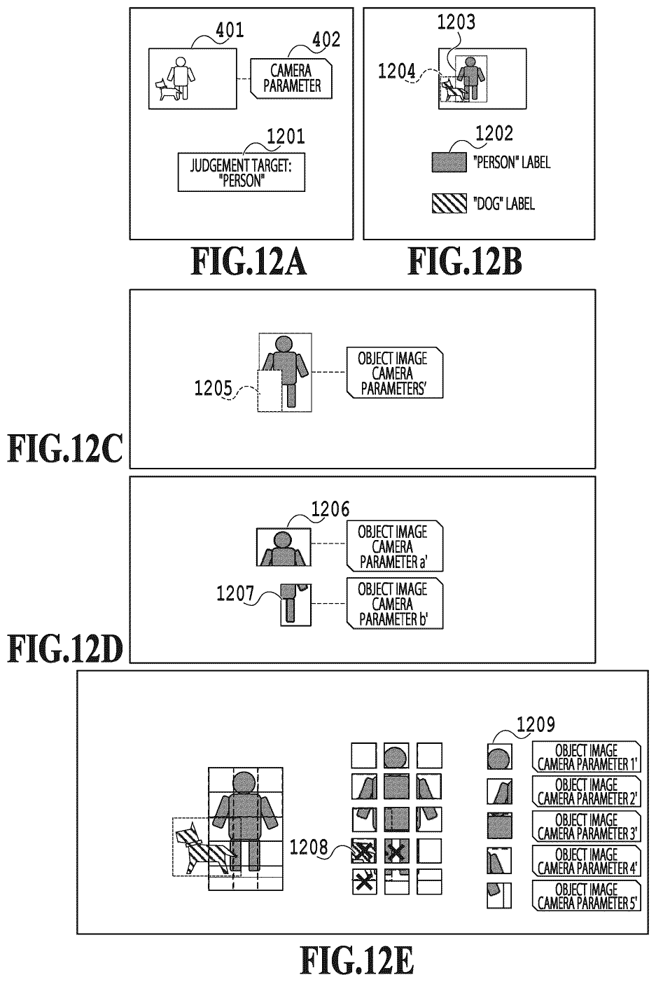

With reference to FIG. 11 and FIG. 12A to FIG. 12E, another extraction method of a foreground region is explained. FIG. 11 is a flowchart showing one example of a processing flow of the image processing apparatus 100 according to another Embodiment. FIG. 12A to FIG. 12E are each a diagram schematically showing one example of an aspect of various pieces of data from obtaining processing of captured image data until generation processing of object image camera parameters in the image processing apparatus 100 according to another Embodiment. In another Embodiment, as one example, a processing method in a case where the object image generation unit 102 in the image processing apparatus 100 extracts the object region in the captured image by using semantic region division. The semantic region division is a method of appending a semantic label for each region semantically different from one another to data of a two-dimensional image or the like and dividing the image into a plurality of image regions.

First, at S1101, the data obtaining unit 101 obtains information on a semantic label 1201 corresponding to a judgement-target object. In the following, explanation is given on the assumption that the judgement-target object is set in advance and the data obtaining unit 101 obtains information on the semantic label 1201 corresponding to the judgement-target object set in advance by reading the information from the auxiliary storage device 206. It may also be possible for a user to set the judgement-target object by using a GUI or the like, not shown schematically. After S1101, at S301, the data obtaining unit 101 obtains data of a plurality of the captured images 401 and the camera parameters 402 corresponding to each captured image 401. The processing at S301 according to another Embodiment is the same as the processing at S301 according to Embodiment 1 or Embodiment 2, and therefore, detailed explanation is omitted.

After S301, at S1102, the object image generation unit 102 performs the semantic region division for each captured image 401 obtained at S301 and appends a semantic label 1202 to the pixel corresponding to the judgement-target object image in each captured image 401. In the following, explanation is given on the assumption that the judgement-target object is a natural person (in the following, simply called “person”). Next, at S1103, the object image generation unit 102 generates an object image 1203 by cutting out a foreground region in the captured image by taking the image region including the pixel to which the semantic label 1202 is appended at S1102 as the foreground region. At this time, as the results of cutting out the image region including the pixel to which the semantic label 1202 is appended into the shape of a rectangle, there is a case where a region 1204 of the pixel to which the semantic label is appended, which corresponds to an object other than the judgement-target object, is included in the object image. In the case such as this, the object image generation unit 102 generates the object image so that the region 1204 of the pixel to which the semantic label corresponding to an object other than the judgement target (in the following, called “non-judgement-target semantic label”) is appended is not included.

As the generation method of an object image in the case such as this, for example, there are three methods (1) to (3) given as examples below.
(1) For the region 1204 of the pixel to which the non-judgement-target semantic label is appended, the object image 1203 to which a non-learning label 1205 is attached is generated.
(2) The object image 1203 is divided so that the region 1204 of the pixel to which the non-judgement-target semantic label is appended is not included and object images 1206 and 1207 corresponding to the object image 1203 are generated.
(3) The object image 1203 is divided into the size of the unit region, which is set in advance, and a unit region 1208 including the pixel to which the non-judgement-target semantic label is appended is excluded, and a corresponding object image 1209 is generated for each unit region other than the unit region 1208.

Here, the non-learning label 1205 is a label for designating the pixel that the space obtaining unit 104 does not use for updating (learning) of spatial information from among the pixels included in the object image.

After S1103, the image processing apparatus 100 performs the processing at S304 and S305 and after the processing at S305, terminates the processing of the flowchart shown in FIG. 11. Each piece of processing at S304 and S305 in another Embodiment is the same as the processing at S304 or S305 in Embodiment 1 or Embodiment 2, and therefore, detailed explanation is omitted.

As above, the image processing apparatus 100 is configured so as to generate the object image and the object image camera parameters corresponding to the object image from the plurality of captured images obtained by image capturing from a plurality of directions and the camera parameters corresponding to each captured image. Further, the image processing apparatus 100 is configured so as to perform updating (learning) of spatial information by using the data of each generated object image and the object image camera parameters corresponding to each object image. According to the image processing apparatus 100 thus configured, compared to the case where the data of all the obtained captured images is loaded onto the VRAM 205, it is possible to perform updating (learning) of spatial information with less memory usage relating to the VRAM 205. Further, according to the image processing apparatus 100 thus configured, compared to the case where updating (learning) of spatial information is performed by using the data of the captured image, it is possible to perform updating (learning) of spatial information with a smaller amount of calculation of the GPU 202.

Further, the image processing apparatus 100 is configured so as not to use the image region corresponding to the image of the object other than the judgement target for updating (learning) of spatial information. According to the image processing apparatus 100 thus configured, it is possible to perform updating (learning) of spatial information with less memory usage relating to the VRAM 205. Furthermore, according to the image processing apparatus 100 thus configured, it is possible to perform updating (learning) of spatial information with a smaller amount of calculation of the GPU 202.

Some embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to reduce memory usage in a case where learning of spatial information is performed.

While the present disclosure has described exemplary embodiments, it is to be understood that some embodiments of the disclosure are not limited to the disclosed exemplary embodiments. The scope of the following claims is to be accorded the broadest interpretation so as to encompass all such modifications and equivalent structures and functions.

This application claims priority to Japanese Patent Application No. 2023-175167, filed on Oct. 10, 2023, which is hereby incorporated by reference wherein in its entirety.

What is claimed is:

1. An image processing apparatus comprising:
one or more hardware processors; and
one or more memories storing one or more programs configured to be executed by the one or more hardware processors, the one or more programs including instructions for:
obtaining data of a plurality of captured images obtained by capturing an object from a plurality of directions and image capturing camera parameters, which are camera parameters corresponding to each of the plurality of captured images;
generating a plurality of object images by extracting an image region corresponding to an image of the object from each of the plurality of captured images;
generating object image camera parameters, which are camera parameters corresponding to each of the plurality of object images, based on the image capturing camera parameters and information indicating a position of an image region corresponding to the image of the object in the plurality of captured images; and
obtaining spatial information representing a space in which the object exists based on the plurality of object images and the object image camera parameters corresponding to each of the plurality of object images.

2. The image processing apparatus according to claim 1, wherein
the one or more programs further include instructions for:
generating an image corresponding to an appearance from a virtual viewpoint based on the object image camera parameters, based on imaginary spatial information and the object image camera parameters and
obtaining of the spatial information is performed by repeating updating of the imaginary spatial information so that a difference between the generated image and the object image corresponding to the object image camera parameters becomes small.

3. The image processing apparatus according to claim 1, wherein
the spatial information includes information representing density at each position in the space.

4. The image processing apparatus according to claim 1, wherein
the spatial information includes information representing a signed distance from the surface of the object at each position in the space.

5. The image processing apparatus according to claim 1, wherein
the spatial information includes information representing a color at each position in the space.

6. The image processing apparatus according to claim 1, wherein
the spatial information includes information representing a color different for different directions at each position in the space.

7. The image processing apparatus according to claim 1, wherein
the one or more programs further include instructions for:
generating an image corresponding to an appearance from an arbitrary viewpoint based on the spatial information.

8. The image processing apparatus according to claim 1, wherein
the image capturing camera parameters include information on a position, an orientation, a focal length, and a principal point of an imaging apparatus used for the image capturing and information on a size of the captured image.

9. The image processing apparatus according to claim 1, wherein
generation of the object image camera parameters is performed by changing information on a size of the captured image and information on a principal point of an imaging apparatus used for the image capturing, both being included in the image capturing camera parameters corresponding to the captured image, based on information indicating a position of an image region corresponding to an image of the object in the captured image.

10. The image processing apparatus according to claim 1, wherein
the one or more programs further include instructions for:
designating resolution of the object image; and
dividing an extracted image region corresponding to an image of the object into a plurality of unit regions based on designated resolution and
generation of the object image is performed by extracting each of the plurality of divided unit regions from the captured image.

11. The image processing apparatus according to claim 1, wherein
the one ore more programs further include instructions for:
classifying the captured image into a foreground region and a background region and
generation of the object image is performed by extracting the classified foreground region from the captured image.

12. The image processing apparatus according to claim 1, wherein
the one or more programs further include instructions for:
obtaining a semantic label designating the processing-target object; and
appending information on a label for semantic classification to part of image regions or pixels in the captured image and
generation of the object image is performed by extracting image regions or pixels to which information on a label corresponding to the sematic label is appended from the captured image.

13. The image processing apparatus according to claim 1, wherein
generation of the object image is performed based on part of regions or pixels of the captured image designated by a user.

14. An image processing method comprising the steps of:
obtaining data of a plurality of captured images obtained by capturing an object from a plurality of directions and image capturing camera parameters, which are camera parameters corresponding to each of the plurality of captured images;
generating a plurality of object images by extracting an image region corresponding to an image of the object from each of the plurality of captured images;
generating object image camera parameters, which are camera parameters corresponding to each of the plurality of object images, based on the image capturing camera parameters and information indicating a position of an image region corresponding to the image of the object in the plurality of captured images; and
obtaining spatial information representing a space in which the object exists based on the plurality of object images and the object image camera parameters corresponding to each of the plurality of object images.

15. A non-transitory computer readable storage medium storing a program for causing a computer to perform a control method of an image processing apparatus, the control method comprising the steps of:
obtaining data of a plurality of captured images obtained by capturing an object from a plurality of directions and image capturing camera parameters, which are camera parameters corresponding to each of the plurality of captured images;
generating a plurality of object images by extracting an image region corresponding to an image of the object from each of the plurality of captured images;
generating object image camera parameters, which are camera parameters corresponding to each of the plurality of object images, based on the image capturing camera parameters and information indicating a position of an image region corresponding to the image of the object in the plurality of captured images; and
obtaining spatial information representing a space in which the object exists based on the plurality of object images and the object image camera parameters corresponding to each of the plurality of object images.
